(19) United States
(12) Patent Application Publication
(10) Pub. No.: US 2008/0265194 A1
(43) Pub. Date: Oct. 30, 2008

(54) Arrangement with a Solenoid Coil and Method for the Production Thereof

(76) Inventors: Bjorn Depoortere, Wingene (BE); Peter Baertsoen, Zulte (BE); Jan Van Cauwenberge, Aalter (BE)

Correspondence Address: BARLEY SNYDER, LLC, 1000 WESTLAKES DRIVE, SUITE 275, BERWYN, PA, 19312, US

(21) Appl. No.: 12/104,472

(22) Filed: Apr. 17, 2008

(30) Foreign Application Priority Data
Apr. 26, 2007 (DE) 102007019800.2

(51) Int. Cl. F16K 31/02

(52) U.S. Cl. 251/129.15

(57) ABSTRACT

An arrangement with a solenoid coil and a solenoid valve includes a yoke housing arranged in a housing. The yoke housing has a first yoke base and a second yoke base. The solenoid coil is arranged between the first yoke base and the second yoke base. The solenoid coil including a coil wound about a coil former. The coil former has a fixing member that fixes the coil former to the housing. The solenoid valve includes a valve housing with a valve base plate connected to the housing. A displaceably mounted valve closing member extends into the solenoid coil from the valve housing. At least one resilient member is provided on an outer face of the second yoke base on a side of the second yoke base remote from the solenoid coil. The resilient member rests on the valve base plate and is compressed thereby.

### CROSS-REFERENCE TO RELATED APPLICATIONS

This application claims the benefit of the filing date under 35 U.S.C. § 119(a)-(d) of German Patent Application No. 10 2007 019 800.2, filed Apr. 26, 2007.

### FIELD OF THE INVENTION

The invention relates to an arrangement with a solenoid coil and a solenoid valve, wherein the solenoid coil is arranged in a yoke housing between a first yoke base and a second yoke base and at least one resilient member is provided on an outer face of the second yoke base that rests on a contact surface and is compressed thereby.

### BACKGROUND

Arrangements comprising solenoid coils are well known in the art. The arrangements include a solenoid coil that is, for example, part of a solenoid valve for controlling a hydraulic flow. In particular, the arrangement with the solenoid coil may be part of the solenoid valve for an antilock braking system of a motor vehicle.

For example, DE 19833498A1 teaches a control device for a hydraulic brake, which comprises a hydraulic unit with a solenoid valve. A cover is provided on a side surface of the hydraulic unit. An electronic control unit is provided with a solenoid coil of the solenoid valve. A coil holder is provided at an opening side of the cover, which coil holder resiliently contacts a lower part of the solenoid coil. The solenoid coil is held in a non-positive manner by the coil holder and a lid of the cover. A resilient material is inserted between an upper part of the solenoid coil and the cover or between a lower part of the solenoid coil and the coil holder. The resilient material which is inserted between the upper part of the solenoid coil and the cover and which is surrounded by protrusions exerts pressure on the solenoid coil and forces the solenoid coil in a direction away from the cover by way of the counterforce of the cover. The resilient material may be an annular rubber material. In the resilient material an opening is formed, into which a convex part of the solenoid coil is inserted. The purpose of the resilient material is to connect the solenoid coil to the solenoid valve cover in a non-positive manner and to act as a sealing material in order to seal openings in the cover.

The coil holder is a support which determines the position of the lower part of the solenoid coil and the purpose of which is to exert a resilient force on the solenoid coil in the direction of the cover. The coil holder comprises an opening, through which a solenoid valve is inserted according to the position of the corresponding solenoid valve. The spring tension on the coil holder is produced by upper protrusions and lower protrusions being formed on both surfaces of the coil holder. The lower protrusions formed on the coil holder resiliently contact the valve block. The coil holder is therefore slightly deformed so as to transfer the deforming force to the lower surface of the solenoid coil via the upper protrusions. As a result, the force which is produced by the resilient material and acts non-positively on the upper and lower parts of the solenoid coil and on the coil holder is greater than before the valve block was assembled.

Furthermore, DE 69809501T2 discloses a solenoid valve arrangement with a resilient member for fixing to a support block, such as a hydraulic block. The electromagnetic valve arrangement comprises a solenoid valve which consists of a coil and a pole mass and comprises spring member for pressing the electromagnetic valve against a support, for example, a hydraulic block. The coil and the pole mass are thus separated from one another and may move relative to one another. Furthermore, the retaining spring members are inserted, on the one hand, between the coil and the support and, on the other hand, between the coil and the pole mass. The spring members are formed of blocks of resilient material, such as rubber.

In addition, a block made of a resilient material, such as rubber, is inserted between a wall and an upper end face of the pole mass. Two resilient support members in the shape of a disc are inserted between a flange and a housing rigidly connected to the coil, the pole mass resting on the flange. The resilient support member accommodates for any changes in the position of the coil and pole mass with respect to a processor. In addition, the pole mass therefore rests permanently on the flange. The arrangement includes an electromagnetic valve and a flange for fixing said valve to a support, such as a hydraulic block, which is provided with a recess in which an element of the electromagnetic valve is received. With regard to the flange fixed to the support, the electromagnetic valve is held at the support by cooperating support surfaces of the flange and of the electromagnetic valve.

Furthermore, a solenoid valve controller is known from DE 102005041240A1, the solenoid valve controller comprising a base, on which an elastomer element is provided projecting inwardly into the control housing. A solenoid coil yoke is provided on the elastomer element, the solenoid coil yoke being pressed together with a control housing directly onto the outer face of a hydraulic device by way of the elastomer element and in the process receiving a solenoid valve of the hydraulic device. On the one hand, the elastomer element serves as a bearing and, on the other hand, the outer face of the hydraulic device serves as an abutment for the solenoid coil yoke, the solenoid coil yoke thus being held in the control housing free of play.

### SUMMARY

It is therefore an object of the invention is to provide an arrangement with a solenoid coil with a resilient member which can be produced in a simpler manner, is more cost-effective and can be individually adapted to a solenoid valve.

This and other objects are achieved by an arrangement with a solenoid coil and a solenoid valve comprising a yoke housing arranged in a housing. The yoke housing has a first yoke base and a second yoke base. The solenoid coil is arranged between the first yoke base and the second yoke base. At least one resilient member is provided on an outer face of the second yoke base on a side of the second yoke base remote from the solenoid coil. The resilient member rests on a contact surface and is compressed thereby.

This and other objects are further achieved by an arrangement with a solenoid coil and a solenoid valve comprising a yoke housing arranged in a housing. The yoke housing has a first yoke base and a second yoke base. The solenoid coil is arranged between the first yoke base and the second yoke base. The solenoid coil including a coil wound about a coil former. The coil former has a fixing member that fixes the coil former to the housing. The solenoid valve includes a valve housing with a valve base plate connected to the housing. A displaceably mounted valve closing member extends into the solenoid coil from the valve housing. At least one resilient member is provided on an outer face of the second yoke base on a side of the second yoke base remote from the solenoid coil. The resilient member rests on the valve base plate and is compressed thereby.

### BRIEF DESCRIPTION OF THE DRAWINGS

FIG. 1 is a schematic view of a cross-section through an arrangement with a solenoid coil;

FIG. 2 is a schematic view of a cross-section through the arrangement with the solenoid coil provided with a solenoid valve;

FIG. 3 is a plan view of a first embodiment of a resilient member;

FIG. 4 is a plan view of a second embodiment of the resilient member; and

FIG. 5 is a plan view of a third embodiment of the resilient member.

### DETAILED DESCRIPTION OF THE EMBODIMENT(S)

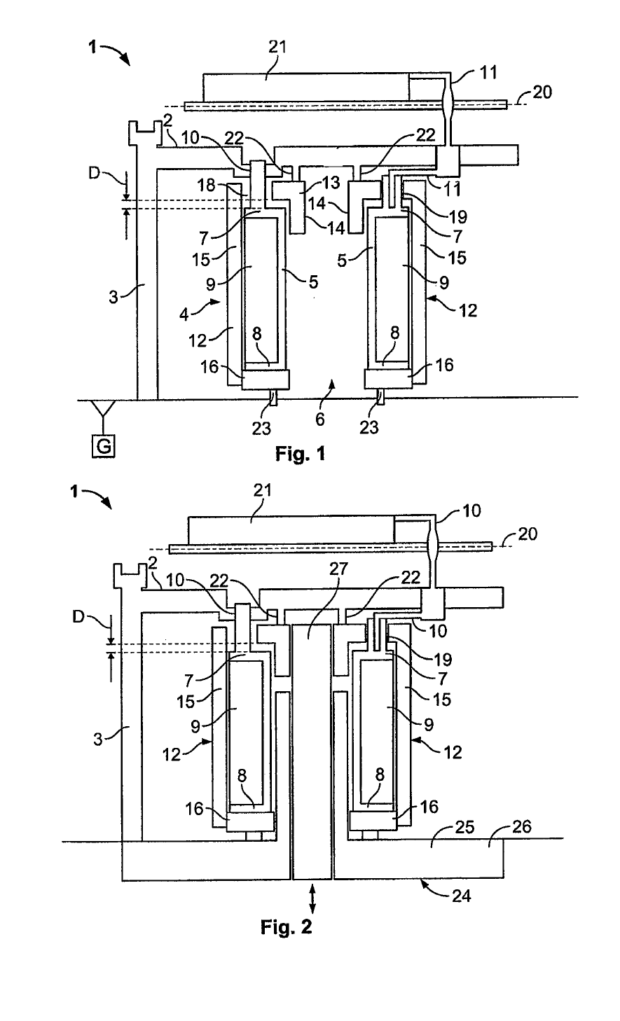

FIG. 1 shows an arrangement with at least one solenoid coil 4. The arrangement comprises a housing 1 provided with a base plate 2 and a side wall 3. The solenoid coil 4 is arranged inside the housing 1 and comprises a coil former 5 and a coil 9. The coil former 5 is a substantially cylinder-shaped sleeve provided with a substantially central cylinder-shaped recess 6. The coil former 5 has first and second cover plates 7, 8 at opposite ends thereof. The first and second cover plates 7, 8 have a substantially annular disc-shape. The coil former 5 is fixed to the base plate 2 via a fixing member 10. The fixing member 10 is formed on the first cover plate 7, which is associated with the base plate 2. The fixing member 10 may be configured as a pin that can be inserted into a recess in the base plate 2. In order to achieve a better fit, the pin may be provided with a contour or ribbing that can engage in a corresponding contour or ribbing of an inner wall of the recess in the base plate 2. A coil wire is wound in the form of a substantially cylinder-shaped coil 9 on an outer face of the coil former 5. The coil 9 is arranged between the first and second cover plates 7, 8.

The solenoid coil 4 is arranged in a yoke housing 12. The yoke housing 12 comprises an annular first yoke base 13 associated with the base plate 2. At an inner edge of the first yoke base 13, a first yoke sleeve 14 is provided that extends from the first yoke base 13 and in part into the recess 6 in the coil former 5. The first yoke base 13 is provided with a first recess 18, through which the fixing member 10 is guided and a second recess 19. The first yoke base 13 preferably rests on support members 22 of the base plate 2. The support members 22 may be configured in the form of individual webs or in the form of an annular web. The first yoke base 13 is spaced at a distance D from the first cover plate 7. The first yoke base 13 and the first cover plate 7 are arranged substantially parallel. Different thermal linear endings can be evened out by the distance D.

On an outer face of the first yoke base 13, a second yoke sleeve 15 is provided that extends from the first yoke base 13 along the solenoid coil 4 to the second cover plate 8 of the coil former 5. A second yoke base 16 having a substantially annular surface is arranged on an outer face of the second cover plate 8 and has an outer edge in contact with an inner face of the second yoke sleeve 15. A central opening 17 in the second yoke base 16 is arranged substantially symmetrically about the recess 6 in the coil former 5. The second yoke base 16 is substantially symmetrical with regard to a center point of a circle. It is therefore not necessary to align the second yoke base 16 in the second yoke sleeve 15 during assembly. The second yoke sleeve 15 comprises an annular opening into which the second yoke base 16 is inserted for assembly.

At least one resilient member 23 is arranged on an outer face of the second yoke base 16. The resilient member 23 is made of a heat-resistant material which can preferably tolerate temperatures of up to 140 degrees Celsius without damaging the resilient member 23. The resilient member 23 may, for example, be produced, at least in part, from silicone. In a further embodiment, the resilient member 23 is made of silicone. The resilient member 23 can be fixed on the second yoke base 16 with the aid of an adhesive joint. In a further embodiment, the resilient member 23 is sputtered directly onto the second yoke base 16 with the aid of a sputtering process. During curing, a binding connection between the resilient member 23 and the second yoke base 16 is produced. After a curing process, which, for example, may take place in a curing oven, the resilient member 23 is finished. Depending on the material used, the sputtered resilient member 23 may be cured without using a curing oven. The sputtering process is particularly suitable for a resilient member 23 which is made, at least in part or completely, of silicone. FIG. 1 shows the resilient member 23 in an unstressed state.

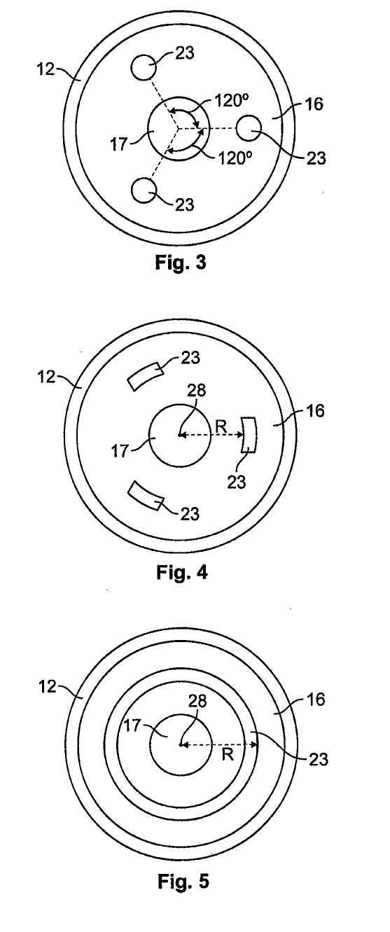

FIG. 3 shows a first embodiment of the resilient members 23. As shown in FIG. 3, the resilient members 23 are substantially circular in shape and are arranged at uniform angular distances with regard to a center axis 28 of the central opening 17 in the second yoke base 16. The angular distances between the center axis 28 of the central opening 17 in the second yoke base 16, the recess 6 in the solenoid coil 4 and adjacent resilient members 23 may be, for example, about 120 degrees. Depending on the selected embodiment, the angle between the adjacent resilient members 23 may vary. A maximum distance between the adjacent resilient members 23 is less than about 180 degrees. Depending on the selected embodiment, two or more than three of the resilient members 23 may also be configured on the second yoke base 16. If there are more than three of the resilient members 23, they may also be arranged with uniform angles between each pair of the adjacent resilient members 23.

FIG. 4 shows a second embodiment of the resilient members 23. As shown in FIG. 4, the resilient members 23 are substantially oblong and cylinder-shaped, in particular in the shape of substantially circular segments, and are arranged on the second yoke base 16. The resilient members 23 are arranged, for example, at a uniform radial distance R from the center axis 28. In addition, the resilient members 23 each have the same cross-section and are equal in length. The resilient members 23 are in the shape of substantially curved cylinders and are produced, for example, by sputtering with a spray nozzle.

FIG. 5 shows a third embodiment of the resilient member 23. As shown in FIG. 5, the resilient member 23 is formed on the second yoke base 16 in this embodiment as a ring, in particular as a closed ring and preferably as an annular ring, in which the second yoke base 16 is preferably arranged symmetrically about the center axis 28 in such a way that the center point of the circle of the resilient member 23 corresponds to the center axis 28. The resilient member 23 may also be in the shape of an open ring instead of being in the shape of a closed ring. In this embodiment, the resilient member 23 may also be sputtered directly onto the second yoke base 16 with the aid of an injection shot.

Electrical connections 11 of the coil 9 are guided from the coil 9 through the second recess 19 in the first yoke base 13 and through a bushing in the base plate 2 to a circuit board 20. The circuit board 20 is arranged outside the housing 1 and comprises at least one electrical circuit 21 which is connected to the electrical connections 11 and which is provided for controlling the solenoid coil 4. The circuit board 20 can be fixed in a further housing or to the base plate 2 of the first housing 1. The electrical circuit 21 may be a control circuit for controlling a magnetic field through the solenoid coil 4. In particular, the electrical circuit 21 may be configured as a control circuit for controlling a solenoid valve 24, such as a solenoid valve of an antilock braking system or an electronic stability program for controlling a motor vehicle.

The solenoid coil 4 is connected to a solenoid valve 24. The solenoid valve 24 is mounted on the housing 1, as shown in FIG. 2. The solenoid valve 24 comprises a valve housing 25 with a valve base plate 26. A displaceably mounted valve closing member 27 is guided through the valve base plate 26. The valve closing member 27 is guided into the recess 6 in the solenoid coil 4. The valve closing member 27 interacts with a control opening in a valve for controlling a liquid. Depending on the power supply to the coil 9, the valve closing member 27 is displaced in an axial direction in the recess 6. An opening cross-section of a control opening is set by the position of the valve closing member 27. A hydraulic flow of a control member is determined by the size of the control opening. The control member may, for example, hydraulic fluid of a braking system or hydraulic fluid of a steering gear of a motor vehicle, which steering gear is assisted by a pressure fluid. The solenoid valve 24 may be part of a hydraulic pressure control system. In addition, the control member may also comprise any other type of medium, such as, for example, fuel. When assembled, the valve base plate 26 is connected to the side wall 3 of the housing 1. The valve base plate 26 serves as a contact surface, against which the resilient member 23 is pressed, so the resilient member 23 is held, at least in part, under compressive stress.

In the arrangement according to the invention, because the resilient member 23 is arranged on a component member, the second yoke base 16, which is cost-effective and easy to dismantle, only the cost-effective component member must be replaced if the resilient member 23 is faulty. As a result, it is possible to reduce the cost of repairing defective parts. An advantage of the arrangement according to the invention is that assembly is simple and it is possible to resiliently fix the solenoid coil in an improved manner. Additionally, the resilient member 23 is arranged on the second yoke base 16, which is arranged directly above the solenoid coil 4. As a result, it is possible to directly transfer force to the solenoid coil 4. The risk of effecting or inducing torque in the solenoid coil 4 when mounting it to a contact surface is thus reduced.

The foregoing illustrates some of the possibilities for practicing the invention. Many other embodiments are possible within the scope and spirit of the invention. For example, only one of the solenoid coils 4 and one of the solenoid valves 24 with the valve closing member 27 are shown in each of the figures. Depending on the selected embodiment, a plurality of the solenoid coils 4 and a plurality of the solenoid valves 24 may be provided. It is, therefore, intended that the foregoing description be regarded as illustrative rather than limiting, and that the scope of the invention is given by the appended claims together with their full range of equivalents.

What is claimed is:

1. An arrangement with a solenoid coil and a solenoid valve, comprising:
a yoke housing arranged in a housing, the yoke housing having a first yoke base and a second yoke base;
the solenoid coil being arranged between the first yoke base and the second yoke base; and
at least one resilient member provided on an outer face of the second yoke base on a side of the second yoke base remote from the solenoid coil, the resilient member resting on a contact surface and being compressed thereby.

2. The arrangement of claim 1, wherein the solenoid coil comprises a coil wound about a coil former, the coil former having a fixing member that fixes the coil former to the housing, the fixing member extending from the coil former through a first recess in the yoke housing to the housing.

3. The arrangement of claim 1, wherein an electrical connection is guided from the solenoid coil through the housing to a circuit board, the circuit board having an electrical circuit for controlling the solenoid coil, the electrical connection being electrically connected to the electrical circuit.

4. The arrangement of claim 1, wherein the solenoid coil is arranged at a distance from the first yoke base of the yoke housing, the first yoke base being fixed to the housing.

5. The arrangement of claim 1, wherein the solenoid valve includes a valve housing connected to the housing, a displaceably mounted valve closing member extending into the solenoid coil from the valve housing.

6. The arrangement of claim 5, wherein the contact surface is a valve base plate of the valve housing.

7. The arrangement of claim 1, wherein the resilient member is at least partially silicone.

8. The arrangement of claim 1, wherein the second yoke base is substantially annular and at least two of the resilient members are provided on the outer face of the second yoke base, the resilient members being arranged at a uniform angular distance from each other.

9. The arrangement of claim 1, wherein the second yoke base is substantially annular and at least two of the resilient members are provided on the outer face of the second yoke base, the resilient members being arranged at a uniform radial distance from a center axis of the second yoke base.

10. The arrangement of claim 1, wherein at least two of the resilient members are provided on the outer face of the second yoke base, the resilient members having the same size and shape.

11. The arrangement of claim 1, wherein the resilient member in a substantially annular ring arranged symmetrically about a center axis of the second yoke base.

12. The arrangement of claim 1, wherein the resilient member is made of a heat resistant material capable of withstanding temperatures up to about 140 degrees Celsius.

13. An arrangement with a solenoid coil and a solenoid valve, comprising:
a yoke housing arranged in a housing, the yoke housing having a first yoke base and a second yoke base;
the solenoid coil being arranged between the first yoke base and the second yoke base, the solenoid coil including a coil wound about a coil former, the coil former having a fixing member that fixes the coil former to the housing;
the solenoid valve including a valve housing with a valve base plate connected to the housing, a displaceably mounted valve closing member extends into the solenoid coil from the valve housing; and
at least one resilient member provided on an outer face of the second yoke base on a side of the second yoke base remote from the solenoid coil, the resilient member resting on the valve base plate and being compressed thereby.

14. The arrangement of claim 13, wherein an electrical connection is guided from the solenoid coil through the housing to a circuit board, the circuit board having an electrical circuit for controlling the solenoid coil, the electrical connection being electrically connected to the electrical circuit.

15. The arrangement of claim 13, wherein the resilient member is at least partially silicone.

16. The arrangement of claim 13, wherein the second yoke base is substantially annular and at least two of the resilient members are provided on the outer face of the second yoke base, the resilient members being arranged at a uniform angular distance from each other.

17. The arrangement of claim 13, wherein the second yoke base is substantially annular and at least two of the resilient members are provided on the outer face of the second yoke base, the resilient members being arranged at a uniform radial distance from a center axis of the second yoke base.

18. The arrangement of claim 13, wherein at least two of the resilient members are provided on the outer face of the second yoke base, the resilient members having the same size and shape.

19. The arrangement of claim 13, wherein the resilient member in a substantially annular ring arranged symmetrically about a center axis of the second yoke base.

20. The arrangement of claim 13, wherein the resilient member is made of a heat resistant material capable of withstanding temperatures up to about 140 degrees Celsius.
